(19) United States
(12) Patent Application Publication
(10) Pub. No.: US 2010/0259481 A1
(43) Pub. Date: Oct. 14, 2010

(54) DATA INPUT DEVICE

(76) Inventor: Eui Jin Oh, Daejeon (KR)

Correspondence Address: LEXYOUME IP GROUP, LLC, 5180 PARKSTONE DRIVE, SUITE 175, CHANTILLY, VA, 20151, US

(21) Appl. No.: 12/745,942

(22) PCT Filed: Dec. 5, 2008
(86) PCT No.: PCT/KR2008/007232

§ 371 Date: Jun. 3, 2010

(30) Foreign Application Priority Data
Dec. 5, 2007 (KR) 10-2007-01255412

(51) Int. Cl. G06F 3/033; G06F 3/02

(52) U.S. Cl. 345/163; 345/168

(57) ABSTRACT

A data input device according to the present invention includes an input unit provided to enable, within a predetermined input region, movement input performed by horizontal movement, central input performed by any of vertical movement and selection of a central input key provided on one side of the input unit, and central and movement input performed by horizontal movement of the input unit when the central input has been performed; a detection unit adapted to detect the horizontal movement of the input unit, a path, and the vertical movement or the selection of the central input key; and a control unit adapted to, based on detection results of the detection unit, extract input commands corresponding to the movement input, the central input and the central and movement input from a memory unit and execute them. Accordingly, the data input device according to the present invention can perform the various functions of the mouse of a desktop computer using a single finger without limitation within a minimum input space by performing various input actions independently or in combination using a single input unit. Furthermore, when characters are performed using the data input device according to the present invention, every character to be input can be input through a single action by combining respective input actions together.

### TECHNICAL FIELD

The present invention relates generally to a data input device, and, more particularly, to a data input device which is capable of performing the various functions of the mouse of a desktop computer using a single finger without limitation within a minimum input space by performing various input actions independently or in combination using a single input unit, and which is capable of inputting every character to be input using a single action by combining respective input actions together.

### BACKGROUND ART

Recently, with the development of software, semiconductor technology and information processing technology, the demand for small size and multi-functionality is gradually increasing.

Accordingly, the importance of input devices which are applied to various pieces of information devices is also increasing. So far input devices have many problems related to the small-sized input space and multi-functionality.

In general, input devices may include keyboard devices for inputting various types of characters and so-called mouse devices for selecting and executing files.

Of these input devices, keyboard devices employ a touch screen method which is applied to Personal Data Assistants (PDAs) or a keypad method which is applied to mobile phones.

However, the above-described touch screen method and keypad method have problems in that input speed is slow, input is inconvenient because repeated input is required, and accuracy is low.

Meanwhile, mouse devices have a problem in that it is difficult to implement small-sized mouse devices due to their characteristics. Although mouse devices are applied to small-sized terminals, there are problems in that only part of the typical mouse functionality that is used in desktop Personal Computers (PCs) can be executed and it is difficult even to conveniently use it.

For example, in order to use a mouse in a portable terminal such as a notebook computer or a PDA, it is necessary to move a mouse pointer using one hand and use the other hand so as to execute the functionality of the right or left button of the mouse. That is, there is a problem in that both hands must be used in order to execute mouse functionality in such a portable terminal.

### DISCLOSURE OF INVENTION

### Technical Problem

Accordingly, the present invention has been made keeping in mind the above problems occurring in the prior art, and an object of the present invention is to provide a data input device which is capable of enabling all the functions of a mouse input device of a desktop PC to be executed using one hand while minimizing an input space by performing various input actions independently or in combination using a single input unit.

A further object of the present invention is to provide a data input device which is capable of freely adjusting the capacity of input and inputting every character through a single action by performing input actions independently or in combination.

### Technical Solution

In order to accomplish the above objects, the present invention provides a data input device, including an input unit provided to enable, within a predetermined input region, movement input performed by horizontal movement, central input performed by any of vertical movement and selection of a central input key provided on one side of the input unit, and central and movement input performed by horizontal movement of the input unit when the central input has been performed; a detection unit adapted to detect the horizontal movement of the input unit, a path, and the vertical movement or the selection of the central input key; and a control unit adapted to, based on detection results of the detection unit, extract input commands corresponding to the movement input, the central input and the central and movement input from a memory unit and execute them.

A contact element is further provided on one side of a bottom of the input unit and configured to project toward the detection unit, and the central input is detected by contact of the contact element with the detection unit, which is caused by the vertical movement of the input unit, and the central and movement input is detected by movement of a contact point, which is caused by the horizontal movement of the input unit that is performed while the contact element is in contact with the detection unit.

A contact element is configured to project from the side of the bottom of the input unit and come into contact with the detection unit, and the central input is detected by any of pressing of the central input key, application of pressure to the center input key, or approaching to or touching of the central input key, and the central and movement input is detected by movement of the contact point of the contact element that is performed when the central input has been detected.

The detection unit may be provided as any one of a touch pad, a touch screen, a capacitive sensor, an optical sensor and a magnetic sensor, which is disposed below the input unit and has a predetermined detection area.

A returning element is further provided between the input unit and the detection unit and adapted to move the input unit upward to an original location after the input unit has been moved downward.

The input unit is provided to enable directional pressing input performed by any of tilting toward each of radial directions at a horizontal location or selection of any of a plurality of directional pressing elements provided to correspond to the respective radial directions and further comprises directional pressing detection elements for detecting the tilting of the input unit or the selection of each of the directional pressing elements, so that the control unit can extract an input command corresponding to the relevant radial direction for which the directional pressing input has been performed from the memory unit and execute it.

The input unit further includes directional touch detection elements for detecting approaching or touching in each of the radial directions, which are provided to correspond to the respective radial directions on a top of the input unit or are provided in the directional pressing detection elements, thereby enabling directional touch input.

One or more of the movement input, the central input, the central and movement input, and the directional pressing input may be provided to enable multi-stage input, that is, two or more-stage input, using any of a difference in moving distance, a difference in moving intensity, and a distance in pressing pressure.

In mouse input mode, movement of a mouse pointer may be performed by the movement input, and a left mouse button function may be performed by the central input that is performed by downward movement of the input unit.

The central input is provided to enable multi-stage input, that is, two or more-stage input, using any of a difference in pressing pressure and a difference in pressing distance, and a right mouse button function may be performed by second-stage central input.

A right mouse button function is performed by any of the directional pressing input and the directional touch input performed in a predetermined radial direction and a predetermined input key provided on a base in which the input unit has been mounted.

The directional pressing input may be provided to be performed in four radial directions, a vertical scroll or shortcut key function is performed by the directional pressing input performed in 12 o'clock and 6 o'clock directions, a right mouse button function may be performed by the directional pressing input performed in a 3 o'clock direction, and a mouse scroll button function may be performed by the directional pressing input performed in a 9 o'clock direction.

A vertical scroll or shortcut key function may be performed using any of a method of performing the directional touch input in a clockwise or counterclockwise direction and a method of rotating the input unit itself in a clockwise or counterclockwise direction.

The directional pressing input is provided to be performed in four radial directions; and in mouse input mode, movement of a mouse pointer may be performed by the movement input, a left mouse button function may be performed by the directional pressing input performed in a 9 o'clock direction, a right mouse button function is performed by the directional pressing input performed in a 3 o'clock direction, and a vertical scroll function may be performed by the directional pressing input performed in 12 o'clock and 6 o'clock directions.

In three-dimensional (3D) graphic work and in mouse input mode, horizontal movement of a 3D object is performed by the movement input, an object 3D rotation function is performed by directional pressing input performed in each of radial directions, an object expansion function may be performed by the central input, and an object two-dimensional (2D) rotation function may be performed by rotation of the input unit itself or directional touch input provided on a top of the input unit.

In mouse input mode, when movement of a mouse pointer may be performed by the movement input, horizontal moving distance of the input unit and moving distance of the mouse pointer are symmetrical, while the mouse pointer may be further moved on a boundary of the input region in a relevant direction even when the horizontal movement of the input unit is stopped.

In mouse input mode, movement of a mouse pointer may be performed by the movement input, selection of an object may be performed by the central input, and a drag function may be performed by the central and movement input.

In mouse input mode, a left mouse button single click function may be performed by the first stage central input, and a left mouse button double click function may be performed by the second stage central input.

The input unit has a plurality of direction indication locations radially arranged around a predetermined reference location; and in character input mode, one or more of central and movement input, directional pressing input and directional touch input toward each of the direction indication locations and movement and central input caused by downward contact after movement toward each of the radial directions are provided to be performed, and different characters are assigned to the respective input actions at each of the direction indication locations and may be then input.

The central and movement input may comprise one or more of outward movement from the reference location to each of the direction indication locations, inward movement and tangential movement at each of the direction indication locations.

In character input mode, a script character input method of tracking a path of the input unit and inputting a character may be provided to be performed.

On the other hand, in order to accomplish the above objects, the present invention provides a data input device, including a base; an input unit provided on the base, the input unit being provided to enable central input performed by any of vertical movement of the input unit itself and selection of a central input key provided on one side of the input unit, movement input performed by the central input after horizontal movement toward any of four direction indication locations radially arranged around a reference location within a predetermined input region, central and movement input performed by horizontal movement toward each of the direction indication locations after the central input, directional pressing input performed by tilting the input unit itself toward each of the direction indication locations at a horizontal location, and directional movement input performed by horizontal movement of the input unit at each of the direction indication locations in each of forward, rearward, rightward and leftward directions to be performed independently; a detection unit adapted to detect the horizontal movement, a path, and vertical movement of the input unit or the selection of the central input key; and a control unit adapted to, based on detection results of the detection unit, extract characters assigned to the respective input actions of the input unit for each of the respective direction indication locations from a memory unit and input them.

Further, in order to accomplish the above objects, the present invention provides a data input device, including a base; two input units provided on the base, each of the input units being provided to enable directional movement input performed when the input unit is horizontally moved at each of four direction indication locations radially arranged around a reference location within a predetermined input region, in four directions, that is, forward, rearward, rightward and leftward directions; a detection unit adapted to detect the direction indication locations at which the directional movement input is performed and a moving direction of the input unit from the relevant direction indication locations; a control unit adapted to, based on detection results of the detection unit, extract characters assigned to the respective input actions of the input unit for each of the respective direction indication locations from a memory unit and input them.

Further, in order to accomplish the above objects, the present invention provides a data input device, including a base; an input unit provided on the base, the input unit being provided to enable central input performed by any of vertical movement of the input unit itself and selection of a central input key provided on one side of the input unit, movement input performed by horizontal movement toward any of eight direction indication locations radially arranged around a reference location within a predetermined input region, and movement and central input performed by the central input that is performed when the movement input has been performed to be performed independently; a detection unit adapted to detect the horizontal movement, a path, and vertical movement of the input unit or the selection of the central input key; and a control unit adapted to, based on detection results of the detection unit, extract characters assigned to the respective input actions of the input unit for each of the respective direction indication locations from a memory unit and input them.

Here, the input unit may comprise two input units provided on the base.

### ADVANTAGEOUS EFFECTS

Accordingly, the data input device according to the present invention is capable of performing the various functions of the mouse of a desktop computer using a single finger without limitation within a minimum input space by performing various input actions independently or in combination using a single input unit.

Furthermore, when characters are performed using the data input device according to the present invention, every character to be input can be input through a single action by combining respective input actions together.

### BRIEF DESCRIPTION OF DRAWINGS

FIG. 1 is a schematic configuration diagram and a conceptual diagram illustrating a data input device according to the present invention;

FIG. 2 is a diagram showing the construction of a data input device according to an embodiment of the present invention;

FIG. 3 is a perspective view showing various embodiments of an input unit that is included in the data input device according to the present invention;

FIG. 4 is a sectional view illustrating movement input, movement and central input and central input that are performed in the data input device according to the present invention;

FIG. 5 is a conceptual diagram illustrating functions assigned to respective input actions in the mouse input mode of the data input device according to the present invention;

FIGS. 6 to 8 are operating diagrams contrasting the input manipulation of the input unit with execution results in mouse input mode;

FIG. 9 is a conceptual diagram illustrating functions assigned to respective input actions in mouse input mode according to another embodiment of the present invention;

FIG. 10 is a conceptual diagram illustrating functions assigned to respective input actions when 3D graphic work is performed using the data input device according to the present invention;

FIG. 11 is a conceptual diagram illustrating horizontal movement within an input region and continuing movement in the boundary of the input region when the data input device according to the present invention is in mouse input mode;

FIGS. 12 to 15 are conceptual diagrams illustrating basic input actions when characters are input using the data input device according to the present invention;

FIGS. 16 to 18 are conceptual diagrams showing various embodiments in which two or more input actions are combined together when characters are input using the data input device according to the present invention;

FIG. 19 is a sectional view showing various embodiments of directional pressing input in the data input device according to the present invention; and

FIG. 20 is a diagram illustrating the movement of a mouse pointer resulting from the movement of the input unit in the present invention.

### MODE FOR THE INVENTION

A data input device according to the present invention will be described in detail below with reference to the accompanying drawings.

Referring to the drawings, the data input device according to the present invention includes an input unit 10 provided to enable movement input M, central input C and central and movement input CM to be performed, a detection unit 20 configured to detect the movement of the input unit 10, and a control unit 30 configured to extract an input command corresponding to each input action from a memory unit 35 on the basis of the detection results of the detection unit 20 and execute the input command.

The input unit 10 is provided to enable movement input M, central input C and central and movement input CM to be performed.

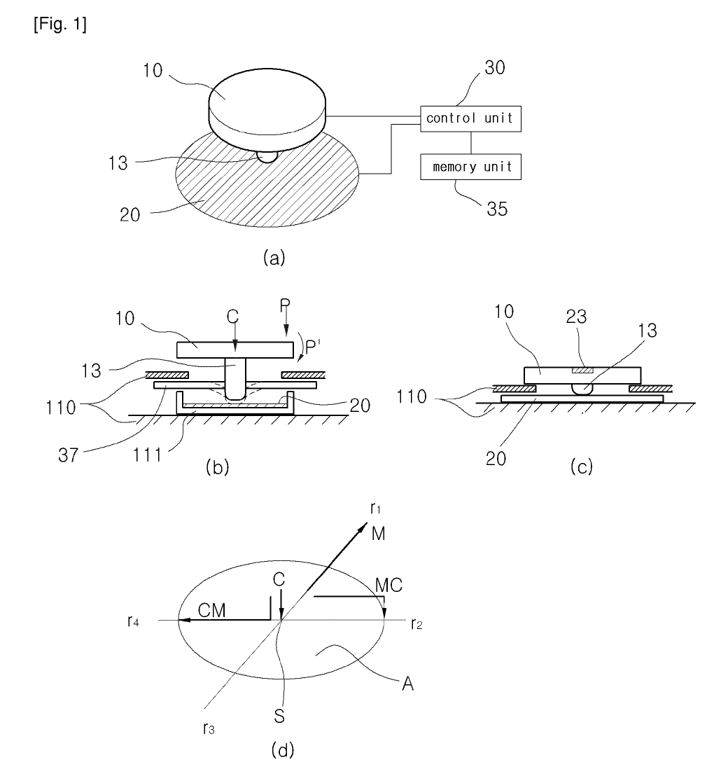

Respective input actions performed using the input unit 10 will be described below with reference to FIG. 1(d).

Movement input M refers to an input action in which the input unit 10 is moved in the horizontal direction of a base 110 or a reference surface within a predetermined input region A.

Movement input M refers to the horizontal movement of the input unit 10 that is performed when central input C has not been performed, and is different from central and movement input CM or movement and central input MC in that it is performed through the combination of central input C and the horizontal movement of the input unit 10.

The direction of the movement input M has no special limitation. That is, the input unit 10 may be moved to predetermined direction indication locations r₁, r₂, . . . in radial directions, as shown in FIG. 1(d), and may be moved in forward and backward directions. The input unit 10 may be freely moved in an every direction, like a mouse or a stylus pen, which is one of the input devices.

Central input C refers to an input action that is performed using a method of moving the input unit 10 in a vertical direction or selecting a central input key 11 provided on one side of the input unit 10.

As described above, central input enables the movement of the input unit 10 to be classified as movement input M, central and movement input CM or movement and central input MC.

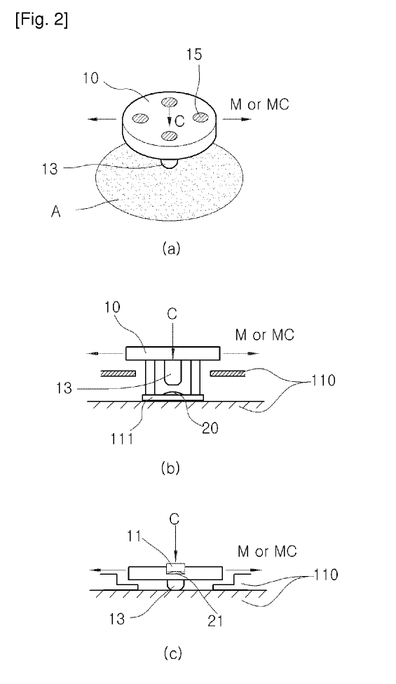

Central input C may be provided using various methods. For example, the input unit 10 may be moved in the vertical direction of the base 110, as shown in FIG. 1(b), a pressure sensor 23 for detecting the vertical pressing of the input unit 10 may be provided on one side of the input unit 10, or a central input key detection unit 21 for detection of the selection of the central input key 11 may be provided on one side of the input unit 10, as shown in FIG. 2(c).

Central and movement input CM refers to an input action in which the input unit 10 performs the above-described vertical movement when central input C has been performed.

Referring to FIG. 1(d), central and movement input CM corresponds to the case where horizontal movement is performed immediately after central input C has been performed, for example, the input unit 10 has been moved downward, while movement and central input MC corresponds to the case where central input C is performed immediately after horizontal movement has been performed.

Meanwhile, directional pressing input P and directional touch input T may be additionally performed through the input unit 10, which will be described together here.

Directional pressing input P refers to an input action that is performed by tilting the input unit 10 itself in each predetermined radial direction, as shown in FIG. 1(b), or by selecting each directional pressing element 15 provided on each side of the input unit 10 to correspond to each radial direction, as shown in FIG. 2(a).

In this case, directional pressing detection elements (not shown) for detecting the tilting the input unit 10 or the selection of directional pressing elements 15 may be further provided.

Accordingly, the control unit 30 extracts an input command corresponding to a relevant radial direction in which directional pressing input P has been performed from the memory unit 35, and executes the input command.

The construction of the performance of directional pressing input P will be described in greater detail below.

Referring to FIG. 19, directional pressing input P may be performed by tilting the input unit 10 toward one of the direction indication locations r₁, r₂, . . . around a contact element 13 (here, the contact element 13 includes not only means for coming into contact with the detection unit 20, but also all types of support means for spacing the input unit 10 apart from the base 110 by a predetermined interval and supporting various pieces of input actions such as the movement of the input unit 10 even though it does not come into contact with the detection unit 20 and does not generate a contact signal), as shown in FIG. 19(a), or by pressing one side of the top of the input unit 10 or one directional pressing element 15 on the top of the input unit 10 without tilting the input unit 10, as shown in FIG. 19(b).

Alternatively, as shown in FIG. 19(c), the input unit 10 and the contact element 13 may be tilted together toward each of the predetermined direction indication locations r₁, r₂, . . . , or only an input unit upper part 18 provided in the upper portion of the input unit 10 may be tilted, as shown in FIG. 19(d).

In the same manner, as shown in FIG. 19(e), when the contact element 13 and the input unit 10 have been tilted together, only the input unit 10 may be tilted toward each of the predetermined direction indication locations r₁, r₂, . . . independently. This case results in the simultaneous application of two different pieces of directional pressing input P.

Alternatively, as shown in FIG. 19(f), when the contact element 13 and the input unit 10 have been tilted together, each of the directional pressing elements 15 on the top of the input unit 10 may be selected.

In particular, FIG. 19(d) shows the simultaneous performance of the horizontal movement of the input unit 10, such as movement input M, and directional pressing input P. This drawing shows the case where the input unit 10 performs horizontal movement to the left of a reference location S and the input unit upper part 18 is tilted to the right and performs directional pressing input P.

The above description describes the case where directional pressing input P can be performed when the input unit 10 has performed horizontal movement (this includes all of movement input M, central and movement input CM and movement and central input MC), and indicates that two independent input actions can be performed together.

Accordingly, in the case where the data input device according to the present invention is used as a mouse device and the function of a left mouse button is assigned to directional pressing input P, the function of the left mouse button can be performed when the input unit 10 has been moved, or the movement of the input unit 10 and the input of the function of the left mouse button can be simultaneously performed, so that the movement of a mouse pointer and the input of the function of the left mouse button, such as text dragging or file movement, can be simultaneously performed. In the case where the function of a right mouse button is assigned to directional pressing input P, the right mouse button may be also pressed freely when the input unit 10 has been or is being moved.

Meanwhile, when the detection unit 20 is formed of an optical sensor, a magnetic sensor or the like, the movement input M and directional pressing input P of the input unit 10 can be performed simultaneously by detecting the tilting the input unit 10 and the tilting the input unit upper part 18.

Directional touch input T refers to an input action that is performed by providing directional touch detection elements 27 on the top of the input unit 10 and detecting a finger's approaching or touching in each radial direction.

Here, the directional touch detection elements 27 may be provided on respective directional pressing elements 15, or may be provided on the top of the input unit 10 to correspond to respective radial directions even when there are no directional pressing elements 15. Furthermore, the directional touch detection elements 27 may be separated from each other and arranged on the outer portion of the top of the input unit 10, or may be provided in the form of a continuous circular strip.

A detailed description will be given below.

Referring to FIG. 1(a), the disc-shaped input unit 10 is provided, and the detection unit 20 is disposed below the input unit 10 while forming a predetermined input region A.

Here, the input unit 10 may be provided in various shapes. For example, as shown in this drawing, it may be provided in a disk shape, in a polygonal plate shape or in a hemispherical shape.

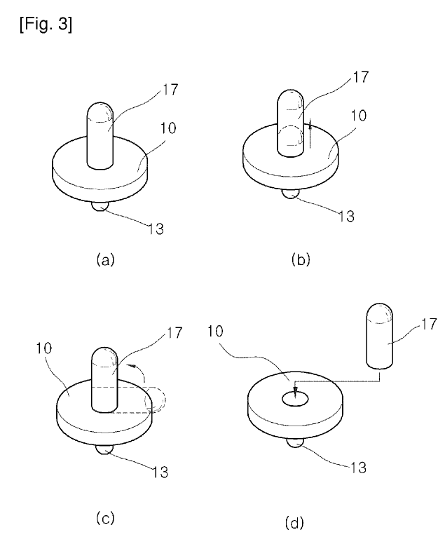

Referring to FIG. 3, a manipulation element 17 for facilitating the manipulation of the input unit 10 may be provided on the input unit 10.

The manipulation element 17 may be provided in a rod shape, as shown in this drawing, or may be provided in various shapes such as a ring shape or a disk shape.

Although the manipulation element 17 may be secured to the input unit 10, the manipulation element 17 may be provided such that it can be extended from or retracted into the input unit 10, as shown in FIG. 3(b), may be tilted to a predetermined direction above the input unit 10, as shown in FIG. 3(c), or may be provided such that it may be selectively attached and detached, as shown in FIG. 3(d).

A contact element 13 projecting toward the detection unit 20 may be provided on one side of the bottom of the input unit 10.

In this case, central input C is detected when the contact element 13 is brought into contact with the detection unit 20 as the input unit 10 is moved downwards, and central and movement input CM is detected when a contact point is moved by horizontal movement when the contact element 13 is in contact the detection unit 20.

The detection unit 20 may be of various forms. For example, the detection unit 20 may be formed of a touch pad, a touch screen, an optical sensor, or a magnetic sensor.

Meanwhile, the present embodiment corresponds to the case where the detection unit 20 is formed of a touch pad or a touch screen. In the initial stage, the input unit 10 is spaced apart from the detection unit 20 at a predetermined interval and the contact element 13 is not brought into contact with the detection unit 20. Thereafter, when central input C is performed by moving the input unit 10 downward, the contact element 13 is brought into contact with the detection unit 20.

Accordingly, before central input C is performed (that is, before the input unit 10 is moved downwards and brought into contact with the contact element 13), no input command is performed by the horizontal movement of the input unit 10. In contrast, after the contact element 13 has been detected by the detection unit 20, the detection unit 20 can detect the location of a contact point, the moving direction of the contact point and the path.

Accordingly, the control unit 30 determines an input action corresponding to the location of a contact point, the moving direction of the contact point and a path, extracts a corresponding input command from the memory unit 35, and executes the input command.

Meanwhile, the embodiment allows various variations in construction. For example, as shown in FIG. 1(b), a support element 111 for restricting or supporting the horizontal movement of the input unit 10 may be further provided between the base 110 and the input unit 10, and the detection unit 20 may be provided inside the support element 111.

Furthermore, a returning element 37 for moving the input unit 10 upward to an original location after the input unit 10 has been moved downward may be provided between the input unit 10 and the detection unit 20.

It will be apparent that the above-described returning element 37 is not limited to the example illustrated in the drawing and may be formed of various pieces of material such as a coil spring, a plate spring or rubber.

Meanwhile, central input C may be performed by pressing a pressure sensor 23 on the input unit 10 rather than moving the input unit 10 downward, as shown in FIG. 1(c), and may be detected by a touch on the center of the top of the input unit 10, an optical sensor, or a magnetic sensor.

In the present embodiment, the contact element 13 always is in contact with the detection unit 20, so that the detection unit 20 can detect movement input M and execute a separate input command in movement input M in which only the horizontal movement of the input unit 10 is performed, unlike in the embodiment shown in FIG. 1(a).

FIGS. 2(a) to 2(c) show examples in which the detection unit 20 for detecting the horizontal movement of the input unit 10 performs detection using methods other than the method of a touch sensor such as that of a touch pad or a touch screen.

That is, central input C is detected using a method of detecting the downward movement of the input unit 10 or the selection of the central input key 11, and the horizontal movement of the input unit 10 is detected within the input space by a non-contact touch sensor such as an optical sensor or a magnetic sensor.

As in the above-described FIG. 1(c), this case has an advantage of performing both movement input M in which central input C is not included, and central and movement input CM or movement and central input MC in which central input C is included.

Here, one or more of the above-described movement input M, central input C, central and movement input CM, directional pressing input P and directional touch input T may be provided such that each of them can perform multi-stage input, that is, two or more-stage input, depending on the difference in moving distance, moving intensity and pressing pressure.

For example, in the case where central input C is detected by the downward movement and contact of the contact element 13, as shown in FIGS. 1(a) and 1(b), when the detection unit 20 is formed of a pressure sensor, multi-stage detection can be performed depending on the difference in the downward pressure of the contact element 13. A two-stage pressing switch may be provided on the bottom of the contact element 13, in which case first stage input may be performed by detecting the contact of the contact element 13 and second stage input may be performed by detecting the downward pressing of the contact element 13.

On the basis of the detection results of the detection unit 20, the control unit 30 extracts an input command corresponding to movement input M, central input C or central and movement input CM from the memory unit 35 and executes the input command.

The memory unit 35 stores input commands corresponding to respective input actions and the directions of the input actions.

For example, when the data input device according to the present invention is used as a mouse, the path of the input unit 10 may be extracted in its original form and input as the movement of the pointer of the mouse.

Alternatively, when the input unit 10 performs central and movement input CM in a 12 o'clock direction from a reference location S, the character ‘A’ may be input (or a ‘menu’ shortcut key function may be performed). Furthermore, when central and movement input CM is performed in a 6 o'clock direction, the character ‘B’ may be input (or a ‘cancel’ shortcut key function may be performed).

Here, another character or a function command may be assigned to movement and central input MC in the 12 o'clock direction.

That is, the data input device according to the present invention may input different characters or execute different functional commands for respective input actions of the input unit 10, and for respective directions of each input action, respective paths and respective locations in the case of each input action.

Mouse Input Mode

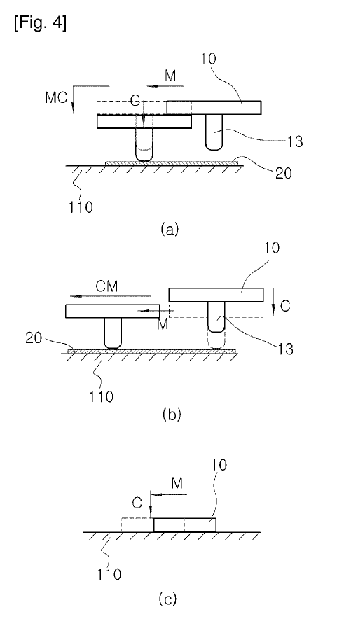

The case where the data input device according to the present invention is used as a mouse, which is one of the input devices, will be described in detail below with reference to FIGS. 4 to 10.

FIG. 4(a) shows an example in which the movement of a mouse pointer and the execution of a left mouse button function are sequentially performed (so-called click after movement), and FIG. 4(b) shows an example in which a left mouse button function is first executed and then a mouse pointer is moved (a so-called drag function).

Referring to FIG. 4(a), a function of moving a mouse pointer to a desired location during the use of a mouse may be performed by performing movement input M, in which the input unit 10 is moved in a horizontal direction, without performing central input C (hereinafter the above two input actions may be collectively referred to as movement and central input MC).

A left mouse button function of clicking a desired folder or icon on an output device, such as a monitor, can be performed by performing central input C in such a way as to move the input unit 10 downward after the input unit 10 has been moved.

Here, the double pressing (a so-called double click) of a left mouse button for executing the folder or icon may be performed. For example, this may be performed in such a way that central input C is configured in a multi-stage manner and second stage input is performed, or may be performed using a separate input action, that is, directional pressing input P in a predetermined radial direction, or using a separate input key provided in the base 110.

FIG. 4(b) shows an example in which the selection of a desired folder or icon (that is, a left mouse button function) is performed by first performing central input C and then a drag function is performed by performing movement input M (hereinafter the two input actions may be collectively referred to as ‘central and movement input CM’ for convenience of description).

Here, the above-described movement and central input MC and central and movement input CM are not limited to the constructions shown in the drawings, but may be variously modified. For example, as shown in FIG. 4(c), the central input C may not be performed by the downward movement of the input unit 10, but may be performed in such a way that a pressure sensor, a touch sensor, a push switch or a dome switch for detecting central input C is provided on or inside the input unit 10, or in such a way that a sensor for detecting the minute downward movement of the input unit 10 or pressing pressure may be provided inside the input region A.

Meanwhile, in each of the above-described embodiments, a right mouse button function may be performed using various methods.

For example, in the case where central input C is provided to perform multi-stage input, that is, two or more-stage input, depending on any one of the intensity of pressing pressure and the difference in pressing distance, the right mouse button function may be performed by second stage central input C.

Alternatively, the right mouse button function may be performed using directional pressing input P or directional touch input T in predetermined radial direction, or using a method of selecting a predetermined input key (not shown) provided in a base (not shown) in which the input unit 10 is mounted.

Meanwhile, the input unit may be implemented differently from those in FIGS. 4(a) to 4(c). That is, the input unit may be provided to generate no signal when central input is not performed on the input unit and the input unit is moved in a horizontal direction, and to activate a mouse pointer when central input is performed. Accordingly, a mouse pointer can be moved only when the input unit is moved in a horizontal direction after central input has been performed by pressing the input unit.

In this case, a left mouse button function may be performed by pressing the input unit when central input has been performed. In this case, when the contact element is brought into contact with the detection unit by pressing the input unit, this is determined to be central input. When the input unit is further pressed, the contact element presses the detection unit, so that the left button of a mouse is determined to have been selected. Alternatively, the input unit may be provided to enable multi-stage pressing, and first stage pressing may be set for the activation of a mouse and second stage pressing may be set for the selection of the left button of the mouse.

Furthermore, in this case, the detection unit may be formed of a touch panel or a tactile sensor. Alternatively, the detection unit may be implemented in a variable resistance fashion. In this case, when a ground signal is applied to the contact element and the contact element is brought into contact with a variable resistance surface element (the detection unit), such as a carbon element, and is then moved, the mouse pointer may be moved according to a resistance value (voltage value) that is uniquely calculated depending on the moving distance and direction (location) of the contact element.

Alternatively, regardless of the presence of the contact element on the bottom of the input unit, the movement of the input unit can be detected using an optical sensor. Alternatively, a magnetic element having magnetic properties may be provided in the input unit or the contact element, the movement of the input unit may be detected using a Hall sensor (magnetic sensor), and the mouse pointer may be moved on the basis of the results of the detection.

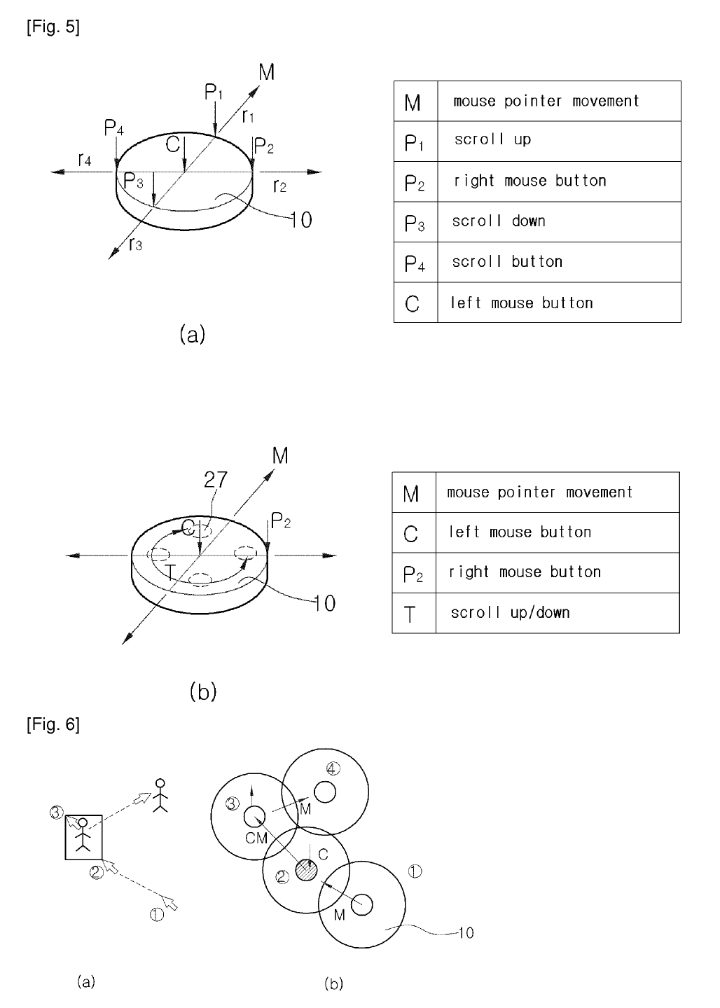

Referring to FIG. 5(a), for example, in the case where directional pressing input P is provided to be performed in four radial directions, a scroll up/down or shortcut key function may be performed by directional pressing input P in 12 o'clock and 6 o'clock directions.

That is, when a scroll up function for raising a page or a scroll down function for lowering a page is performed because a page is long during the use of a computer, the scroll up function may be performed by performing directional pressing input P₁ on the relevant page in a 12 o'clock direction or the scroll down function may be performed by performing directional pressing input P₃ on the relevant page in a 6 o'clock direction.

Meanwhile, when directional pressing input P₄ is performed in a 9 o'clock direction, a scroll button command to select a predetermined point by pressing the scroll wheel of a mouse input device and then perform a scroll up/down function by moving the mouse input device may be executed.

Here, a right mouse button function is performed by directional pressing input P₂ in a 3 o'clock direction.

Alternatively, as shown in FIG. 5(b), the scroll up/down or shortcut key function may be performed by performing directional touch input T in a clockwise or counter-clockwise direction in the case where the input unit 10 can perform directional touch input T or by rotating the input unit 10 itself in a clockwise or counterclockwise direction.

That is, a scroll up function is performed by performing directional touch input T in a clockwise direction, while a scroll down function is performed by performing directional touch input T in the opposite direction.

Here, the scroll up/down function may be performed by rotating the input unit 10 itself in a clockwise direction or in the opposite direction.

FIGS. 6 to 8 show mouse movement and drag functions in detail.

The left diagram of FIG. 6 shows the movement of an actual mouse pointer displayed on a monitor, and the right diagram thereof sequentially shows input actions using the input unit 10.

Referring to this drawing, a mouse pointer is moved to a predetermined location by first performing movement input M (\textcircled{1}). Thereafter, a start point for selecting a relevant object is set by performing central input C (a left mouse button function, \textcircled{2}). Then the relevant object is selected by performing central and movement input CM (a drag function, \textcircled{3}). Finally, the object is moved to the predetermined location by releasing the central input C and then performing movement input M (\textcircled{4}).

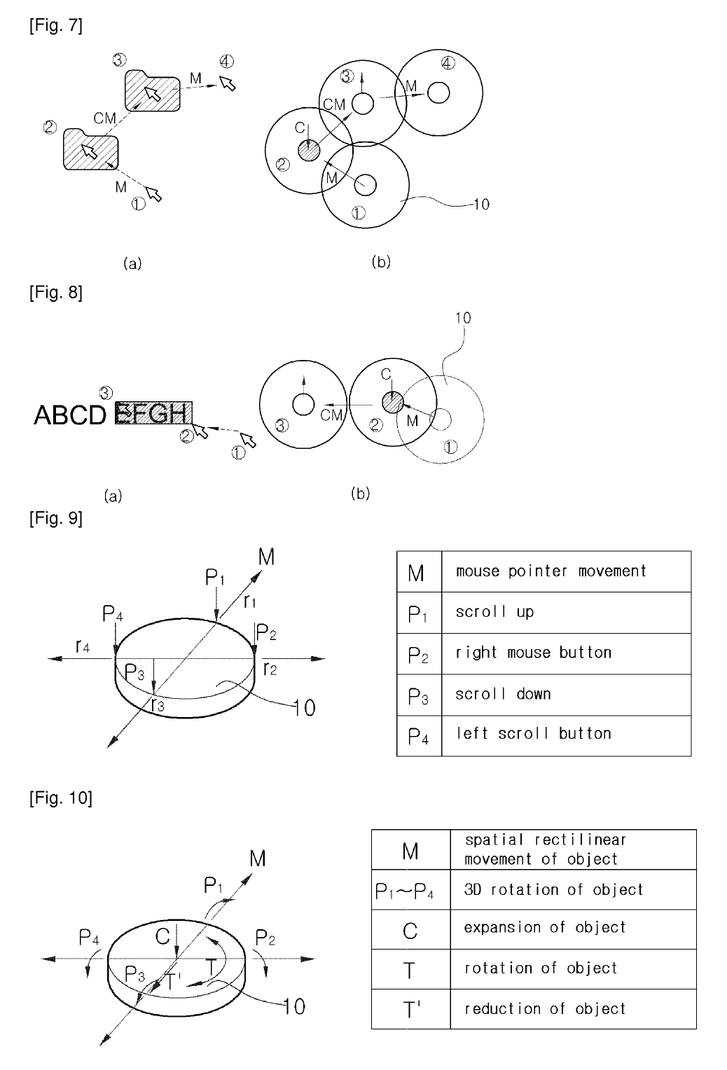

FIG. 7 shows the selection and movement of a file using the data input device according to the present invention.

Referring to this drawing, first, a mouse pointer is moved to a predetermined location by performing movement input M (\textcircled{1}). Thereafter, a relevant object is selected by performing central input C (a left mouse button function, \textcircled{2}). Then the selected object is moved by performing central and movement input CM (a drag function, \textcircled{3}). Finally, the object is moved to the predetermined location by releasing the central input C and then performing movement input M (\textcircled{4}).

FIG. 8 shows the selection of part of a character string using the data input device according to the present invention.

First, a mouse pointer is moved to a predetermined location by performing movement input M (\textcircled{1}). Thereafter, a start point for selecting a relevant character string is set by performing central input C (a left mouse button function, \textcircled{2}). Thereafter, the relevant character string is selected by performing central and movement input CM (a drag function, \textcircled{3}). Finally, the object is moved to the predetermined location by releasing the central input C and then performing movement input M (\textcircled{4}).

Meanwhile, when the input unit 10 has four direction indication locations r₁, r₂, . . . , as shown in FIG. 9, the movement of a mouse pointer may be performed by movement input M, a scroll up function may be performed by directional pressing input P₁ in a 12 o'clock direction, a right mouse button function may be performed by directional pressing input P₂ in a 3 o'clock direction, a scroll down function may be performed by directional pressing input P₃ in a 6 o'clock direction, and a left mouse button function may be performed by directional pressing input P₄ in a 9 o'clock direction.

Referring to FIG. 10, three dimensional (3D) object programming, that is, graphic work, may be performed using the data input device according to the present invention.

Referring to this drawing, the horizontal movement of a 3D object may be performed by movement input M, a function of performing the 3D rotation of the object may be performed by directional pressing input P toward each of the direction indication locations r₁, r₂, . . . , a function of expanding the object may be performed by central input C, and the two dimensional (2D) rotation of the object may be performed by the rotation of the input unit 10 itself or directional touch input T on the input unit 10.

In this case, a function of reducing the object may be performed by performing directional touch input T in a predetermined radial direction, for example, 6 o'clock direction, from the center of the input unit 10.

Here, the horizontal movement of a 3D object refers to the rectilinear movement of the object in 3D space defined by x, y and z axes, and the 3D rotation of an object refers to the rotation of the object in a 3 o'clock direction on the basis of an axis passing through a 12 o'clock point and a 6 o'clock point in the case where the object is rotated, for example, in a P₂ direction.

Furthermore, the 2D rotation of an object refers to the rotation of the object around an axis along which central input C is performed.

Here, in each of the above-described embodiments, various functions based on the variations of the input actions may be added.

For example, In the case where movement input M, central and movement input CM or movement and central input MC is performed in a multi-stage manner, when second stage input is performed, the moving speed of a mouse pointer may be faster than that which is achieved by first stage input.

Alternatively, various pieces of input window control, such as the expansion/reduction of an input window, the turning over of a window to the previous or subsequent window, the opening/closing of an input window, the viewing of a desktop or the popping up of an input window, can be performed by second stage input.

Alternatively, various pieces of shortcut keys, such as a space key, an Esc key and a Shift key, may be assigned to respective pieces of second input, and the second input may be used to perform a scroll up/down function in 3D graphic work.

Alternatively, a left mouse button function and a double click function are assigned to second stage central input and second stage directional pressing input P, so that the expansion/reduction of an input window and the opening/closing of an input window can be easily performed.

Meanwhile, in the above-described embodiments, when the data input device according to the present invention is used as a mouse, there may occur a case where it is not easy to move a mouse pointer to a desired location because the input region A is smaller than an area through which an actual mouse pointer can be moved.

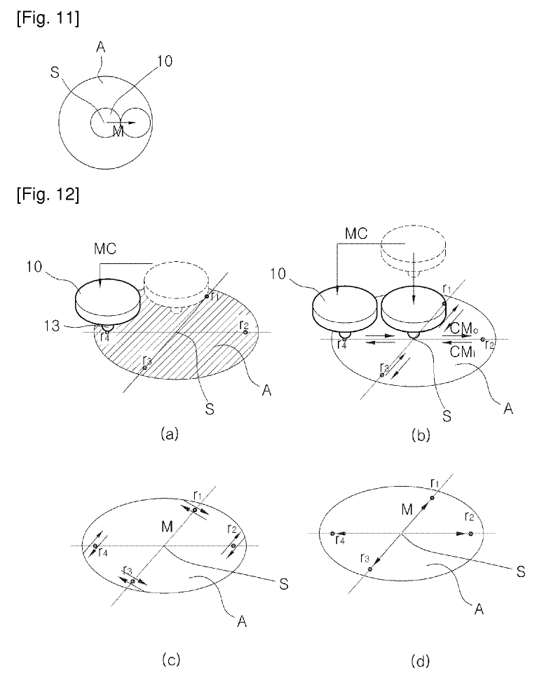

Accordingly, the data input device according to the present invention may be configured such that when, for example, the movement of a mouse pointer is performed by movement input M, as shown in FIG. 11, the horizontal moving distance of the input unit 10 and the moving distance of the mouse pointer are the same from the point of view of absolute distance. However, in the case where the movement of the input unit 10 is not further performed on the boundary of the input region A, the mouse pointer is further moved in a relevant direction even when the horizontal movement of the input unit 10 is stopped.

That is, even though no further horizontal movement of the input unit 10 is performed on the boundary of the input region A, the continued movement of the mouse pointer is performed in the case where the movement input M is continued.

Here, when horizontal movement is performed within the input region A, a larger amount of pointer movement may be predetermined in proportion to the speed of movement to a location.

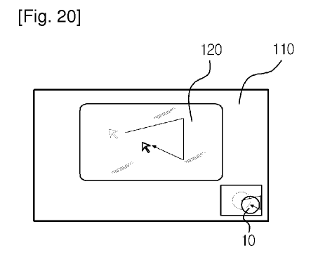

Alternatively, as shown in FIG. 20, the input region A and the movement of the mouse pointer may be configured to be symmetrical. Here, ‘symmetrical movement’ refers to the case where the ratio of the movement of the input unit 10 to the movement of the mouse pointer is 1:1, or the case where the movement of the mouse pointer is accelerated depending on the moving speed of the input unit 10. In this case, when the input unit 10 stops movement without performing a returning function while moving, the state may be maintained. That is, in the above-described embodiment, the input unit 10 may or may not have a returning function depending on a signal processing method.

In the case where a returning function is provided, the pointer may not be returned until the input unit 10 has been moved and then is returned to its reference location.

However, in the case where a returning function is provided and the movement of the input unit 10 and the movement of the mouse pointer are symmetrical, when the input unit 10 is moved in a predetermined direction and returned toward the reference location and a user intends to move a mouse pointer in another direction, the mouse pointer may be moved along with the input unit 10. In contrast, in the case where it is desired that the input unit 10 automatically return to the reference location after a user has performed input, the mouse pointer must be prevented from operating.

Accordingly, when the input unit 10 moves the mouse pointer and when the input unit terminates input and returns to its original location, different pieces of processing must be performed.

This method may be implemented in such a way that the input unit 10 is spaced apart from the top of the detection unit 20 by a predetermined interval, and, when a finger is softly placed on and presses the input unit 10, the input unit 10 is moved downward and the contact element 10 of the input unit is brought into contact with the detection unit 20, so that a mouse pointer function is activated. That is, when the contact element 13 is brought into contact with the detection unit 20, the mouse pointer is activated, so that the mouse pointer is continuously moved in the case where the input unit 10 is moved while in contact with the detection unit 20. Furthermore, when force is released from the finger or the finger is removed from the input unit, the input is terminated, the input unit 10 is moved upward, is moved away from the detection unit 20, and is returned to its reference location. Accordingly, even though the input unit 10 is returned to its original location, the mouse pointer remains at a location where the input was terminated.

When the input unit 10 is not spaced apart from the detection unit 20 but is in contact with the detection unit 20 and downward pressing pressure is generated by the pressing of a user's finger, central input may be performed and the mouse pointer may be activated. Here, central input may be implemented using a pressure sensor or a metal dome.

Alternatively, first data may be input by the movement of input unit 10, and second data may be input by the movement of the input unit 10 with the contact element 13 of the input unit in contact with the detection unit 20.

For example, characters may be input by the movement of the input unit and a mouse pointer may be moved by the movement of the input unit with the contact element of the input unit in contact with the detection unit, and vice versa. However, in this case, during movement input using the input unit, the input unit 10 is pressed, so that the contact element 13 is unintentionally brought into contact with the detection unit 20, with the result that the undesired input of second data may occur. Accordingly, even though the contact element 13 is brought into contact with the detection unit 20 during the input of first data, the input of second data may be performed only in the case where contact continues for a period equal to or longer than a predetermined period, in the case where contact movement is performed over a distance equal to or longer than a predetermined distance, in the case where a signal having a pressure value equal to or greater than a predetermined pressure value is generated by pressing the input unit using force with a value equal to or greater than a predetermined value, or in the case where a predetermined pressing signal is generated.

Using the data input device having the above-described construction, when a mouse function is performed in a portable terminal, the movement of a mouse pointer and the use of right and left buttons can be freely performed using a single finger.

That is, in order to use a mouse in a portable terminal such as a notebook computer or a PDA, a mouse pointer must be moved using one hand, and the other hand must be used to perform the right/left button function of the mouse. That is, in order to perform mouse functions in such a portable terminal, both hands must be used.

However, the data input device according to the present invention enables all types of input of a mouse, such as the movement of a mouse pointer, the pressing of right/left buttons and scroll, using a single input unit 10, that is, a single finger.

Since the pressing of a left mouse button together with movement input M can be performed by performing central input C or directional pressing input P while performing movement input M, file drag, text input and the like performed in a desktop PC can be performed using a single finger, and the pressing of a right mouse button can be performed during movement using a single finger.

Accordingly, the input unit 10 occupies a smaller area of a terminal than that which is used by both hands, and enables one hand to hold a grip of a subway train because it requires only a single hand.

Furthermore, the data input device according to the present invention is capable of inputting script characters in such a way as to place a finger on the input unit 10, as in writing using a pen, through the combination of movement input M and central input C or directional pressing input P, or is capable of inputting 24 Korean characters or 26 English characters using predetermined input forms in one-character-input-by-one-action manner, thereby performing very fast character input within a minimum input space.

Character Input Mode

Meanwhile, the data input device according to the present invention may be used as a character input device for inputting Korean characters, English characters or Japanese characters.

The use of the character input mode will be described below in detail with reference to FIGS. 12 to 17.

First, FIGS. 12 to 15 illustrate a method of inputting characters using respective direction indication locations r₁, r₂, . . . radially arranged around the reference location S.

Prior to the description, it is noted that the number of direction indication locations r₁, r₂, . . . is not limited to the number shown in the drawings and may vary if necessary. Accordingly, the case where the number of direction indication locations r₁, r₂, . . . is four or eight is described as an example.

Referring to FIG. 12, the input unit 10 has a plurality of direction indication locations r₁, r₂, . . . radially arranged around the reference location S, and is provided to perform one or more of central and movement input CM, directional pressing input P and directional touch input T toward direction indication locations r₁, r₂, . . . and downward contact-based movement and central input MC after the movement in each radial direction. Respective characters are assigned to the direction indication location r₁, r₂, . . . for each input, and then the respective characters are input.

FIG. 12(a) illustrates movement and central input MC that is performed when the input unit 10 is moved from the reference location S toward each of the predetermined direction indication locations r₁, r₂, . . . and then performs central input C. Here, since different characters are assigned to respective direction indication locations r₁, r₂, . . . , the character ‘A’ is input when the contact of the input unit 10 is detected in the radial direction r₁ and the character ‘B’ is input when the contact of the input unit 10 is detected in the radial direction r₃, in an example.

As described above, it is apparent that when the number of direction indication locations r₁, r₂, . . . is increased, the number of characters that can be input by movement and central input MC is also increased.

FIG. 12(b) illustrates central and movement input CM that is performed when central input C is performed at the reference location S and the input unit 10 is moved toward each of the direction indication locations r₁, r₂, . . . .

In this case, outward movement M₀ in which the input unit 10 is moved toward each of the direction indication locations r₁, r₂, . . . from the reference location S and inward movement Mᵢ in which the input unit 10 is moved in the opposite direction are classified as different input actions, so that different characters may be assigned thereto, so that a total of eight characters can be input even when four direction indication locations r₁, r₂, . . . are present.

FIG. 12(c) illustrates central and movement input CM that is performed in directions tangent to the direction indication locations r₁, r₂, . . . . In this case, different characters can be assigned to the directions of each piece of central and movement input CM.

FIG. 12(d) illustrates movement input M that is performed toward each of the direction indication locations r₁, r₂, . . . from the reference location S. This input is distinguished from input in FIG. 12(b) in that this input does not include central input C. It will be apparent that different characters may be assigned to the direction of each movement input M.

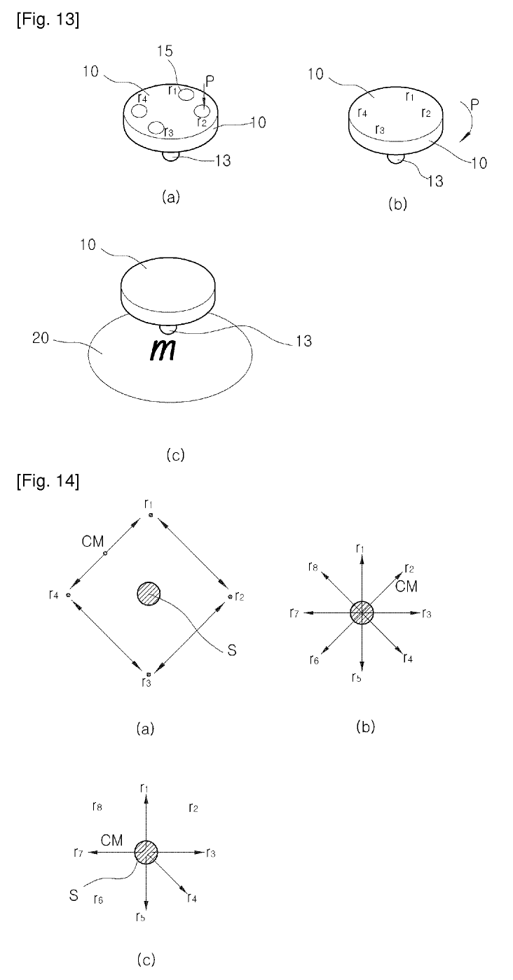

Meanwhile, FIGS. 13(a) and 13(b) illustrate examples in which characters are input by directional pressing input P. FIG. 13(a) illustrates the example in which input is performed by selecting directional pressing elements 15 provided on one side of the input unit 10 to correspond to respective direction indication locations r₁, r₂, . . . , and FIG. 13(b) illustrates the example in which input is performed by tilting the input unit 10 itself.

FIG. 14(a) illustrates a method of performing central and movement input CM on the input unit 10 between the direction indication locations r₁, r₂, . . . , and FIG. 14(b) illustrates the case where central and movement input CM is performed in a path from each of the direction indication locations r₁, r₂, . . . through the reference location S toward another one of the direction indication locations r₁, r₂, . . . .

As described above, in the case where central and movement input CM is performed through the reference location S, the movement through the reference location S toward another one of the direction indication locations r₁, r₂, . . . , shown in FIG. 14(c), as well as rectilinear movement can be performed.

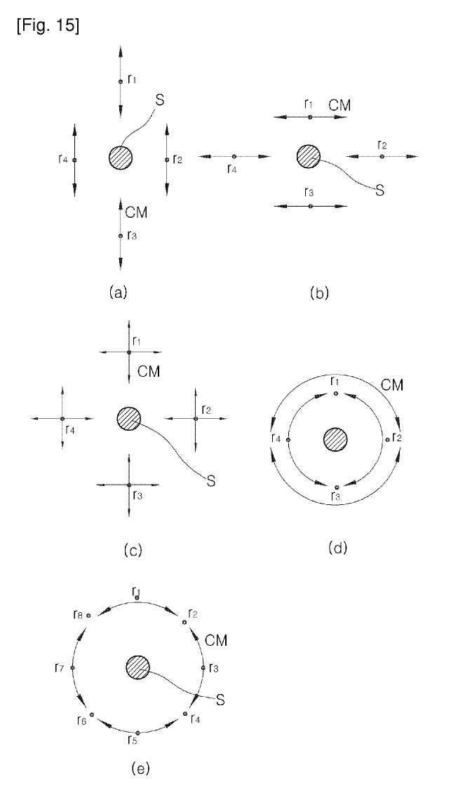

FIG. 15 illustrates examples of various input actions.

FIG. 15(a) illustrates an example in which central and movement input CM is performed at each of the direction indication locations r₁, r₂, . . . in forward and rearward directions, and FIG. 15(b) illustrates an example in which central and movement input CM is performed in rightward and leftward directions.

Meanwhile, central and movement input CM may be performed at each of the direction indication locations r₁, r₂, . . . in forward and rearward directions, as shown in FIG. 15(c), and circumferential central and movement input CM may be performed between the direction indication locations r₁, r₂, . . . , as shown in FIGS. 15(d) and 15(e).

Meanwhile, FIG. 13(c) illustrates script-type character input that is performed by tracking the path of the contact element 13 and inputting a character, as with an electronic pen or a stylus pen that is used in a touch pad or a touch screen.

The above-described input actions may be used independently or in combination (representative embodiments in which respective input actions are combined together will be described in detail below).

Since characters can be assigned to respective input actions independently and the number of characters varies depending on the number of direction indication locations r₁, r₂, . . . , every desired character can be input by a single input action through the combination of an appropriate number of input actions and an appropriate number of direction indication locations r₁, r₂, . . . .

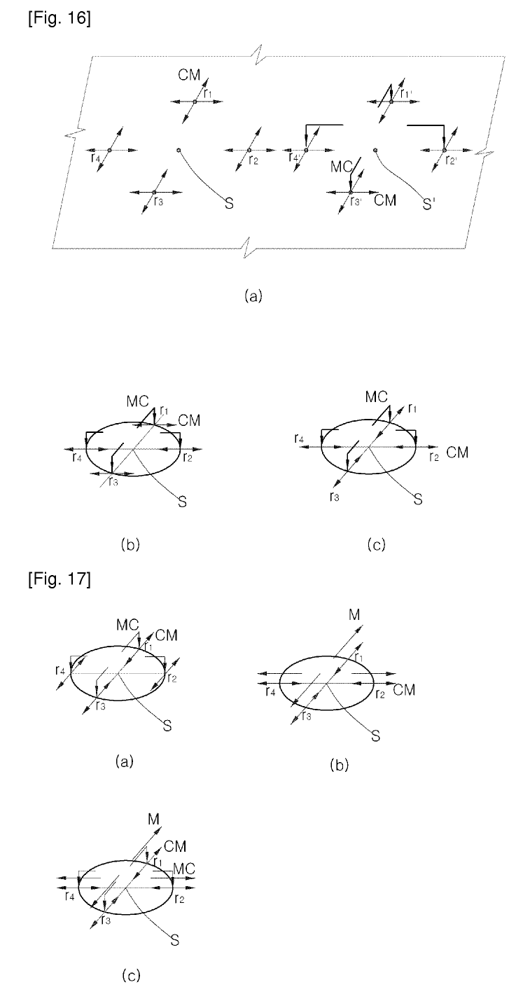

The embodiments in which the above-described input actions are combined together will be described in detail below with reference to FIGS. 16 to 18 (for convenience of illustration, in the drawings, the input unit(s) 10 is (are) omitted and respective input actions are schematically illustrated).

Referring to FIG. 16(a), two input units 10 are provided on the right and left sides of the input region A, respectively, and each of the input units 10 has four direction indication locations r₁, r₂, . . . around a relevant reference location S.

Each of the input units 10 is provided to enable central and movement input CM at each of the direction indication locations r₁, r₂, . . . in four directions, that is, forward, rearward, rightward and leftward directions.

Accordingly, since four characters are assigned to each of the direction indication locations r₁, r₂, . . . and two input units 10 are provided, a total of 4×4×2 characters, that is, 32 characters, can be assigned.

Accordingly, since they are enough for the assignment of 24 Korean characters and 26 English characters, various types of function commands, such as Space, Enter and Cancel, may be additionally assigned to the remaining input actions.

Meanwhile, as shown in the left diagram of FIG. 16(a), in the case where movement and central input MC is additionally performed at each of the direction indication locations r₁, r₂, . . . , 20 characters can be input using each of the input units 10.

Alternatively, in the case where a single input unit 10 is provided, four pieces of central and movement input CM are performed at each of four direction indication locations r₁, r₂, . . . in forward, rearward, rightward and leftward directions and four pieces of central and movement input CM, four pieces of movement input M and four pieces of directional pressing input P are additionally combined together, so that a total of 28 pieces of character input can be performed.

FIG. 16(b) illustrates an example in which at four direction indication locations r₁, r₂, . . . , two pieces of central and movement input CM at each of the direction indication locations r₁, r₂, . . . in forward and rearward directions and four pieces of movement and central input MC toward respective direction indication locations r₁, r₂, . . . are combined together. In this case, 12 pieces of character input can be performed using a single input unit 10.

FIGS. 16(c) and 17(a) illustrate the case where the number of characters that can be input is identical to that in FIG. 16(b) and implementation can be achieved by the combination of different input actions.

That is, FIG. 16(c) illustrates an example in which central and movement input CM is performed at respective direction indication locations r₁, r₂, . . . in tangential directions, FIG. 17(a) illustrates an example in which central and movement input CM is performed at respective direction indication locations r₁, r₂, . . . in forward and rearward directions.

Meanwhile, FIG. 17(b) illustrates an example in which the input unit 10 has four direction indication locations r₁, r₂, . . . and four pieces of movement input M and eight pieces of central and movement input CM are performed at respective direction indication locations r₁, r₂, . . . in radial directions. Accordingly, a total of 12 pieces of character input can be performed.

FIG. 17(c) illustrates an example in which the input unit 10 has four direction indication locations r₁, r₂, . . . and four pieces of movement input M, four pieces of movement and central input MC and eight pieces of central and movement input CM are combined together, so that a total of 16 character inputs can be performed.

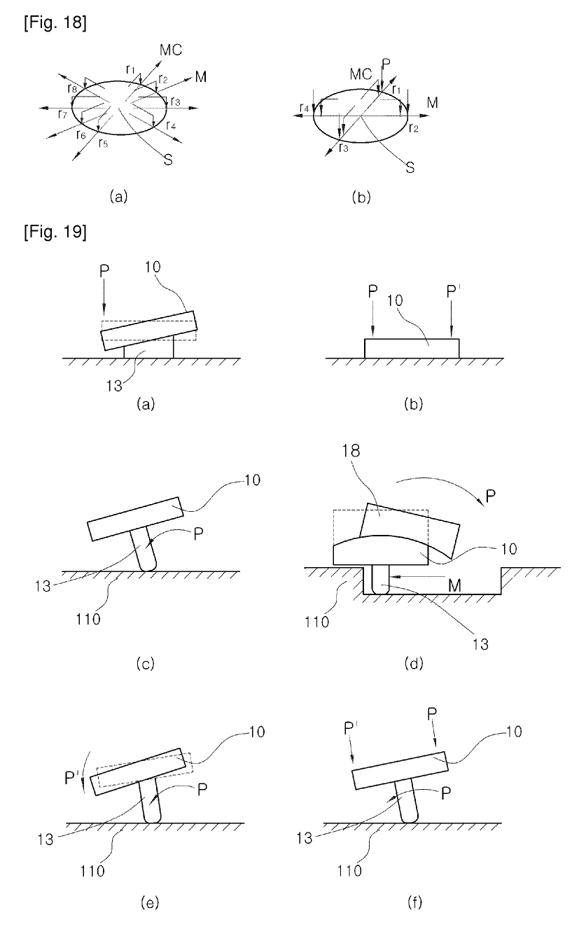

FIG. 18(a) illustrates an example in which at four direction indication locations r₁, r₂, . . . , four pieces of directional pressing input P, four pieces of movement input M and four pieces of movement and central input MC are combined together, so that 12 pieces of character input can be performed.

Finally, FIG. 18(b) illustrates an example in which eight direction indication locations r₁, r₂, . . . are provided and eight pieces of movement and central input MC and eight pieces of movement input M are combined together for respective direction indication locations r₁, r₂, . . . , so that a total of 16 pieces of character input can be performed.

Here, a highly integrated input space can be provided in such a way as to perform directional pressing input P subsequently to central and movement input CM, or perform directional pressing input P subsequently to central and movement input CM, when necessary.

Accordingly, in the case of Korean character input, double consonants and diphthongs can be additionally assigned.

Meanwhile, the above-described directional pressing input P after central and movement input CM forms an input action different from that of independent directional pressing input P. That is, in the case where four direction indication locations r₁, r₂, . . . are provided, when central and movement input CM and directional pressing input P are performed independently, eight pieces of character input can be performed. However, after movement toward any one of the direction indication locations r₁, r₂, . . . has been performed, four pieces of directional pressing input P can be newly performed at the corresponding direction indication location, so that a total of 16 pieces of character input can be additionally assigned.

Accordingly, it is also noted that new input actions can be constructed by sequentially combining the above-described input action together as described above.

The data input device according to the present invention enables the number of input characters to be freely adjusted by combining various input actions together and adjusting the number of direction indication locations r₁, r₂, . . . if necessary, in addition to the above-described embodiments.

For example, in the case where in the above-described eight embodiments, the number of direction indication locations r₁, r₂, . . . is four, the capacity of input can be doubled by configuring each input action in two stages, providing two input units 10, or increasing the number of direction indication locations r₁, r₂, . . . to eight.

Furthermore, since respective types of input action to be combined together do not need to have the same number of direction indication locations r₁, r₂, . . . , the capacity of input can be freely adjusted by flexible design change, as in the case where movement input M or center combinational input has eight direction indication locations r₁, r₂, . . . and directional pressing input P has four direction indication locations r₁, r₂, . . . .

The rights of the present invention are not limited to the above-described embodiments, but are defined only by the claims. It will be apparent that those who have ordinary skill in the technical field of the present invention can make various modifications and variations within the scope of the rights that are described in the claims.

1. A data input device, comprising: an input unit provided to enable, within a predetermined input region, movement input performed by horizontal movement, central input performed by any of vertical movement and selection of a central input key on one side of the input unit, and central and movement input performed in combination with the central input and the movement input; a detection unit adapted to detect the horizontal movement, a path and the vertical movement of the input unit or the selection of the central input key; and a control unit adapted to, based on detection results of the detection unit, extract input commands corresponding to the movement input, the central input and the central and movement input from a memory unit and execute them.

2. The data input device as set forth in claim 1, further comprising a contact element provided on one side of a bottom of the input unit and configured to project toward the detection unit, wherein the central input is detected by contact of the contact element with the detection unit, which is caused by the vertical movement of the input unit, and the central and movement input is detected by movement of a contact point, which is caused by the horizontal movement of the input unit that is performed while the contact element is in contact with the detection unit.

3. The data input device as set forth in claim 2, further comprising a contact element configured to project from the side of the bottom of the input unit and come into contact with the detection unit, wherein the central input is detected by any of pressing of the central input key, application of pressure to the center input key, or approaching to or touching of the central input key, and the central and movement input is detected by movement of the contact point of the contact element that is performed when the central input has been detected.

4. The data input device as set forth in claim 1, wherein the detection unit is formed of any of a touch pad, a touch screen, a capacitive sensor, an optical sensor, a tactile sensor, a variable resistance sensor or a magnetic sensor, which is disposed below the input unit and has a predetermined detection area.

5. The data input device as set forth in claim 2, further comprising a returning element provided between the input unit and the detection unit and adapted to move the input unit upward to an original location after the input unit has been moved downward.

6. The data input device as set forth in claim 1, wherein the input unit is provided to enable directional pressing input performed by any of tilling toward each of radial directions at a horizontal location or selection of any of a plurality of directional pressing elements provided to correspond to the respective radial directions, further comprising directional pressing detection elements for detecting the tilting of the input unit or the selection of each of the directional pressing elements, wherein the control unit extracts an input command corresponding to the relevant radial direction for which the directional pressing input has been performed from the memory unit and executes it.

7. The data input device as set forth in claim 6, further comprising directional touch detection elements for detecting approaching or touching in each of the radial directions, which are provided to correspond to the respective radial directions on a top of the input unit or are provided in the respective directional pressing elements, thereby enabling directional touch input.

8. The data input device as set forth in claim 7, wherein one or more of the movement input, the central input, the central and movement input, the directional touch input and the directional pressing input are provided to enable multi-stage input, that is, two or more-stage input, using any of a difference in, moving distance, a difference in moving velocity, a difference in pressing distance and a difference in pressing pressure.

9. The data input device as set forth in claim 7, wherein, in mouse input mode, one or more of movement of a mouse pointer, drag, click, scroll, an object selection, and an object movement, an object rotation, an object reduction or expansion, control of moving speed of a mouse pointer, input window control and shortcut key function are performed by any one or more or the combination of the movement input, the central input, the central and movement input, the directional touch input and the directional pressing input.

10. The data input device as set forth in claim 1, wherein the input unit further comprises a manipulation element for facilitating the manipulation of the input unit.

11. The data input device as set forth in claim 1, wherein the central input is detected by a detecting unit provided on the top of or inside the input unit.

12-14. (canceled)

15. The data input device as set forth in claim 1, wherein the input region is configured to be symmetrical with the movement of the mouse pointer.

16. The data input device as set forth in claim 1, wherein in mouse input mode, when movement of a mouse pointer is performed by the movement input, horizontal moving distance of the input unit and moving distance of the mouse pointer are symmetrical, while the mouse pointer is further moved on a boundary of the input region in a relevant direction even when the horizontal movement of the input unit is stopped.

17-18. (canceled)

19. The data input device as set forth in claim 7, wherein: the input unit has a plurality of direction indication locations radially arranged around a predetermined reference location; and in character input mode, one or more of the central and movement input, the directional pressing input and the directional touch input toward each of the direction indication locations and movement and central input caused by downward contact after movement, toward each of the radial directions are provided to be performed, and different characters are assigned to the respective input actions at each of the direction indication locations and are then input.

20. The data input device as set forth in claim 19, wherein the central and movement input comprises one or more of outward movement from the reference location to each of the direction indication locations, inward movement and tangential movement at each of the direction indication locations.

21. The data input device as set forth in claim 1, wherein in character input mode, a script character input method of tracking a path of the input unit and inputting a character is provided to be performed.

22. A data input device comprising:
a base;
an input unit provided on the base, the input unit being provided to enable central input performed by any of vertical movement of the input unit itself and selection of a central input key provided on one side of the input unit, movement and central input performed by the central input after horizontal movement toward any of four or eight direction indication locations radially arranged around a reference location within a predetermined input region, central and movement input performed by horizontal movement toward each of the direction indication locations after the central input, directional pressing input performed by tilting the input unit itself toward each of the direction indication locations at a horizontal location, and directional movement input performed by horizontal movement of the input unit at each of the direction indication locations in each of forward, rearward, rightward and leftward directions to be performed independently;
a detection unit adapted to detect the horizontal movement, a path, and vertical movement of the input unit or the selection of the central input key; and a control unit adapted to, based on detection results of the detection unit, extract characters assigned to the respective input actions of the input unit for each of the respective direction indication locations from a memory unit and input them.

23-24. (canceled)

25. The data input device as set forth in claim 22, wherein the input unit comprises two input units provided on the base.
